(19) United States
(12) Patent Application Publication
(10) Pub. No.: US 2015/0278656 A1
(43) Pub. Date: Oct. 1, 2015

(54) JOB DISCRIMINATION METHOD AND DEVICE

(71) Applicant: FUJITSU LIMITED, Kawasaki-shi (JP)

(72) Inventors: Keigo MITSUMORI, Kobe (JP); Toru KITAYAMA, Kobe (JP); Masahiro FUKUDA, Nagoya (JP); Masashi KATOU, Nagoya (JP); Haruki HATTORI, Inazawa (JP); Masakazu FURUKAWA, Yoro (JP); Shotaro OKADA, Nishinomiya (JP); Ryota KAWAGATA, Kobe (JP)

(73) Assignee: FUJITSU LIMITED, Kawasaki-shi (JP)

(21) Appl. No.: 14/626,991

(22) Filed: Feb. 20, 2015

(30) Foreign Application Priority Data
Mar. 25, 2014 (JP) 2014-062555

(51) Int. Cl. G06K 15/02

(52) U.S. Cl. CPC G06K 15/1809

(57) ABSTRACT

A job discrimination device includes a processor that executes a procedure. The procedure includes: acquiring input-output information including information of an input file from which a job reads data, information of input data included in the input file, information of an output file to which the job writes data, information of output data included in the output file, and information of an access method to the output file; and discriminating, as a data alteration job, a job in which a pattern indicated by a relationship between the number of the input files and the number of the output files, a relationship between the number of input data items and the number of output data items, a relationship between the input data and the output data, and an access method to the output file matches a pattern arising when processing having a processing result independent of unit processed is executed.

### CROSS-REFERENCE TO RELATED APPLICATION

This application is based upon and claims the benefit of priority of the prior Japanese Patent Application No. 2014-062555, filed on Mar. 25, 2014, the entire content of which is incorporated herein by reference.

### FIELD

The embodiments discussed herein are related to a job discrimination method, a job discrimination device, and a recording medium at which a job discrimination program is stored.

### BACKGROUND

Hitherto, technology has been proposed that automatically generates job control text for parallel execution of plural job steps that were originally executed sequentially in the job. In this technology, for example, job execution information, job step execution information, and data access information are extracted from a job execution history file, and relationships are defined between the job, the job steps, and the data access information. Job step network information is then generated indicating correspondences between job steps that perform input/output processing, and job steps that are executed prior to these job steps. Moreover, monitoring is performed in this technology to determine, from the data access information of each job, whether or not sequential access to the output file of a prior job has been performed, and whether or not a subsequent job will sequentially access an input file. Then, determination is made that parallel execution is possible when both jobs sequentially access respective files.

### RELATED PATENT DOCUMENTS

Japanese Laid-Open Patent Publication No. H10-214195

### SUMMARY

According to an aspect of the embodiments, a job discrimination method includes: acquiring input-output information including an information of input file from which a job that executes specific processing reads data, information of input data included in the input file, information of an output file to which the job writes data, information of output data included in the output file, and information of an access method to the output file; and by a processor, based on the input-output information, discriminating, as a data alteration job, a job in which a pattern indicated by a relationship between a number of the input files and a number of the output files, a relationship between a number of items of the input data and a number of items of the output data, a relationship between the input data and the output data, and the access method to the output file, matches a pattern predetermined as a pattern arising when processing having a processing result independent of a processing unit is executed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a schematic of batch processing;

FIG. 2 is a diagram to explain waiting time in batch processing;

FIG. 3 is a diagram illustrating relationships between output data of a prior job and processing initiation of a subsequent job;

FIG. 4 is a diagram to explain processing units of aggregation processing;

FIG. 5 is a diagram to explain processing units of aggregation processing;

FIG. 6 is a diagram to explain aggregation results when aggregation processing is executed in parallel;

FIG. 7 is a functional block diagram illustrating a schematic configuration of a job discrimination device according to an exemplary embodiment;

FIG. 8 is a schematic diagram illustrating functional sections that function when a server installed with a job discrimination device according to the exemplary embodiment operates in a test environment;

FIG. 9 is a schematic diagram illustrating functional sections that function when a server installed with a job discrimination device according to the exemplary embodiment operates in a real operation preparation environment;

FIG. 10 is a schematic diagram illustrating functional sections that function when a server installed with a job discrimination device according to the exemplary embodiment operates in a real operation environment;

FIG. 11 is a diagram illustrating an example of a job definition file;

FIG. 12 is a diagram illustrating an example of a run result management table;

FIG. 13 is a diagram illustrating an example of a table of correlation relationships between extraction jobs and subsequent jobs;

FIG. 14 is a diagram illustrating an example of an execution time table of observation target jobs;

FIG. 15 is a diagram illustrating an example of average correlation values tabulated with a run result management table;

FIG. 16 is a diagram illustrating an example of an observation candidate overview screen;

FIG. 17 is a diagram illustrating an example of an observation target job list;

FIG. 18 is a diagram illustrating an extraction job schematic;

FIG. 19 is a diagram to explain capture processing;

FIG. 20 is a diagram illustrating an example of a read processing management table;

FIG. 21 is a diagram illustrating an example of a write processing management table;

FIG. 22 is a diagram illustrating an example of a file offset processing management table;

FIG. 23 is a block diagram illustrating a schematic configuration of a computer that functions as a job discrimination device according to the exemplary embodiment;

FIG. 24 is a flowchart illustrating an example of test operation processing;

FIG. 25 is a flowchart illustrating an example of application execution time processing;

FIG. 26 is a flowchart illustrating an example of data read analysis processing;

FIG. 27 is a flowchart illustrating an example of data write analysis processing;

FIG. 28 is a flowchart illustrating an example of alteration job discrimination processing;

FIG. 29 is an example of a flowchart illustrating an example of real operation preparation processing;

FIG. 30 is a flowchart illustrating an example of real operation processing;

FIG. 31 is a diagram to explain an advantageous effect according to the exemplary embodiment; and

FIG. 32 is a diagram to explain an advantageous effect according to the exemplary embodiment.

### DESCRIPTION OF EMBODIMENTS

Detailed explanation follows regarding an example of an exemplary embodiment according to technology disclosed herein with reference to the drawings.

First, explanation is given regarding issues related to batch processing to clarify jobs to be discriminated in the present exemplary embodiment.

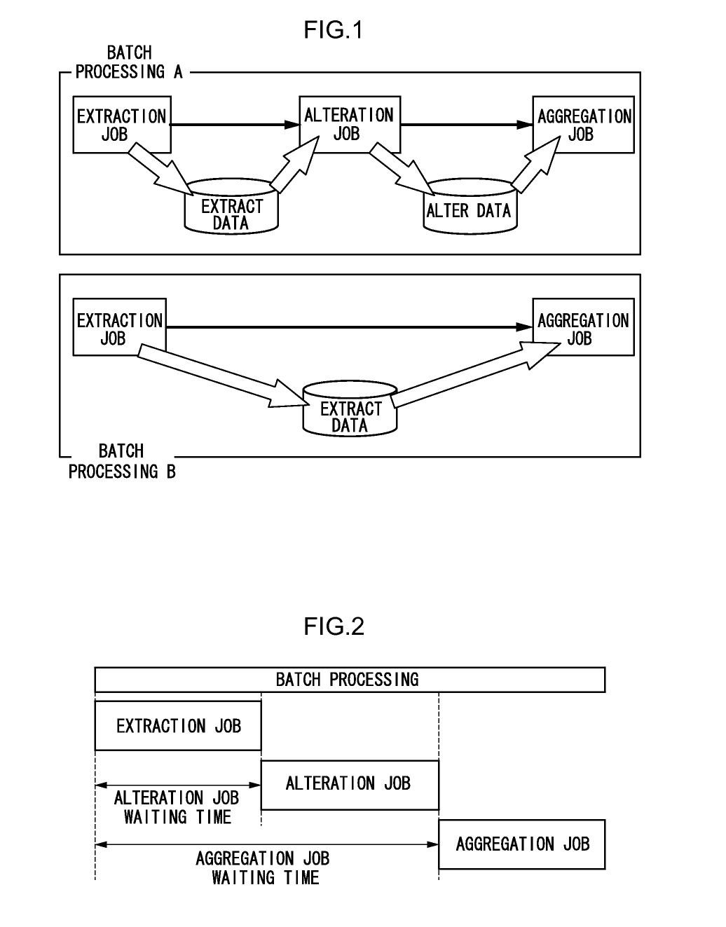

The batch processing is essentially unified processing of various data accumulated in online processing. In the batch processing, there are many cases in which a job that executes data extraction processing, a job that executes data alteration processing, and a job that executes data aggregation processing, are executed in this sequence, as in batch processing A illustrated in FIG. 1. Jobs that execute data extraction processing are referred to below as extraction jobs, jobs that execute data alteration processing are referred to as alteration jobs (data alteration jobs of technology disclosed herein), and jobs that execute data aggregation processing are referred to as aggregation jobs. Moreover, batch processing also exists in which output data of the extraction job, rather than output data of the alteration job, is input data of the aggregation job, as in batch processing B illustrated in FIG. 1.

In batch processing, the next job is started after the immediately prior job finishes, as illustrated in FIG. 2. Thus, the processing time for jobs to execute each type of processing increases as the amount of data handled increases, increasing the waiting time for jobs that execute subsequent processing. The scheduled completion time for the overall batch processing is therefore sometimes delayed.

Hitherto, delays in such batch processing have been detected, the delay notified to an operations manager, and rescheduling of the job executed in the batch processing prompted. However, in consideration of quality, cost, delivery (QCD) perspectives, and the expansion of systems to be managed in recent years, it is desirable to not only monitor delays, but to also automate the delay avoidance performed by an operations manager.

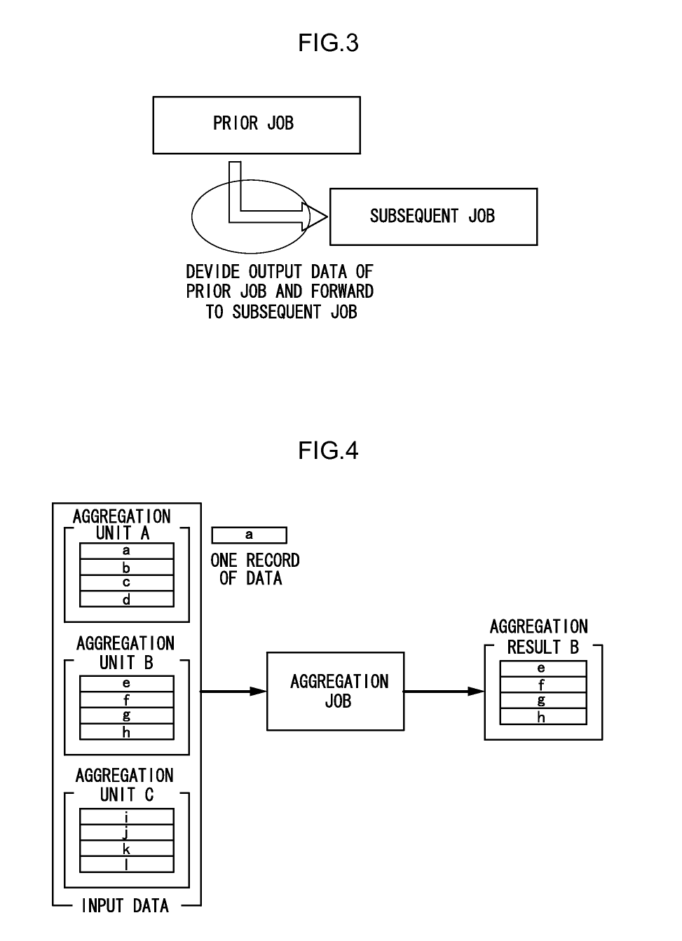

Reducing the time taken overall for batch processing by parallel execution of jobs to be sequentially processed is conceivable by conventional technology. For example, as illustrated in FIG. 3, it is possible to initiate processing of the subsequent job by dividing up output data arising as the processing result of a prior job, and forwarding the output data to the subsequent job, without waiting for completion of the prior job. Namely, it is possible to perform parallel execution of the prior job with the subsequent job.

Herein, in the batch processing A illustrated in FIG. 1, for example, a case is conceivable in which the extraction job that is the prior job, and the alteration job that is the subsequent job, are executed in parallel. In such cases, execution of the intended processing is possible without issues regarding the characteristics of the alteration job even when processing is initiated in the alteration job using divided output data forwarded from the extraction job.

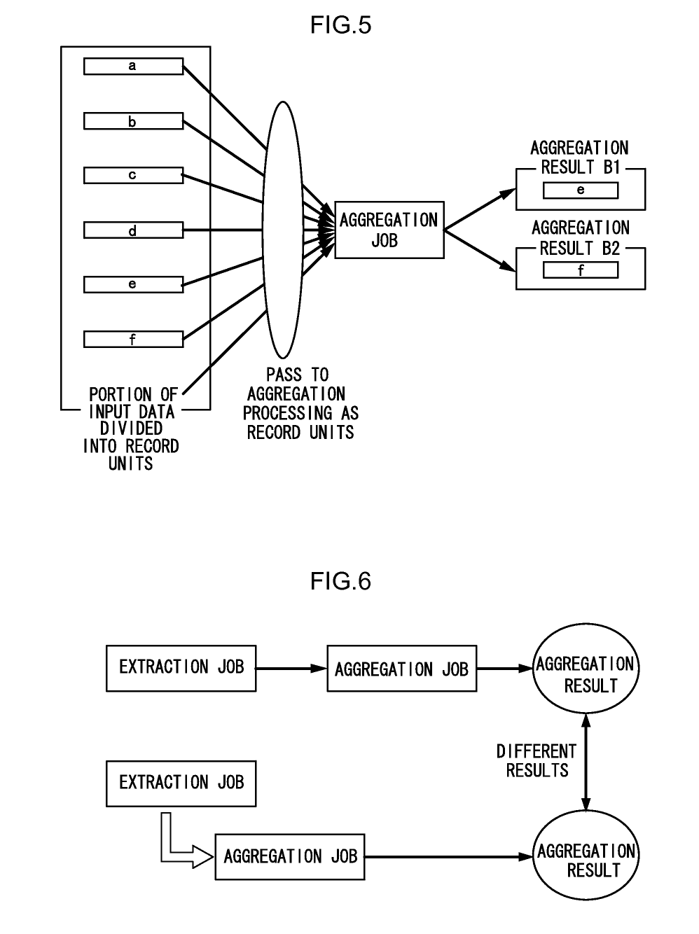

However, issues arise when the subsequent job is an aggregation job, as in the batch processing B illustrated in FIG. 1. As illustrated in FIG. 4, in aggregation jobs, correct units of data are needed for aggregation, and the correct aggregation result is obtained by performing aggregation with the respective units. However, as illustrated in FIG. 5, there are cases in which aggregation processing is not be performed accurately when such input data is divided into record units and the aggregation processing performed on those respective units, since the aggregation units subject to aggregation breakdown.

For these reasons there are cases, as illustrated in FIG. 6, in which the aggregation result when the extraction job and the aggregation job are executed sequentially, and when the extraction job and the aggregation job are executed in parallel, differ from one another. Parallel execution of the extraction job with the aggregation job should therefore be avoided.

Consider a case, as in conventional technology, in which determination as to what kind of processing the subsequent job performs is not made, even though determination is made as to whether access to an output file of the prior job, and access to an input file of the subsequent job, are sequential or not. Such a case would sometimes result in determination that an extraction job is executable in parallel with an aggregation job, even for the batch processing B illustrated in FIG. 1, giving output of an erroneous aggregation result, and resulting in business issues.

In order to discriminate jobs executable in parallel, discrimination is accordingly made as to whether or not to access to the output file of the prior job and access to the input file of the subsequent job are sequential. In addition thereto, discrimination may be made as to whether the subsequent job is an alteration job having a processing result independent of unit processed, rather than an aggregation job.

Alteration jobs included in applications are typically developed without consideration of parallel execution, and the content of alteration jobs include the execution of various types of alteration processing. Jobs therein that obtain an accurate processing result even when executed in parallel is not be identified using only externally observable information (access patterns to input files and output files).

In the present exemplary embodiment jobs executable in parallel are accordingly discriminated by analyzing detailed file access patterns observed in processing characteristics of the alteration job, and determining whether or not parallel execution is possible.

Next, detailed description follows regarding a job discrimination device according to the present exemplary embodiment. In the job discrimination device of the present exemplary embodiment, when a delay to overall batch processing is detected in an extraction job, discrimination is made as to whether or not a subsequent job to the extraction job is as an alteration job executable in parallel. When discrimination is of an alteration job executable in parallel, the extraction job is then caused to execute in parallel with the alteration job, avoiding delay to the overall batch processing.

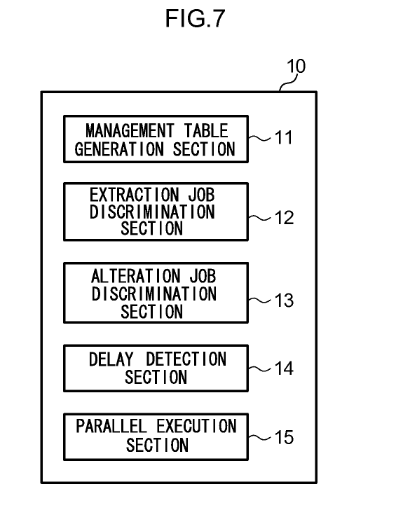

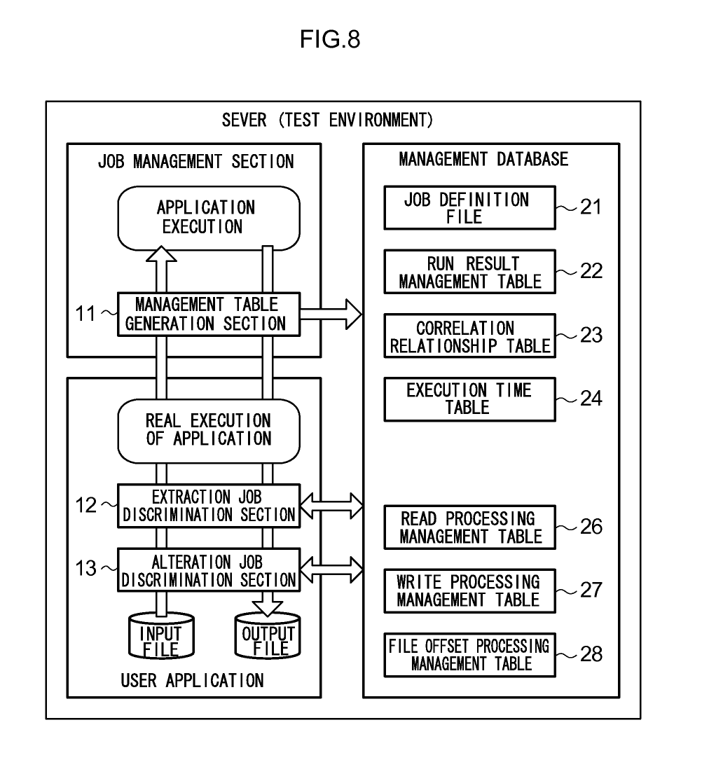

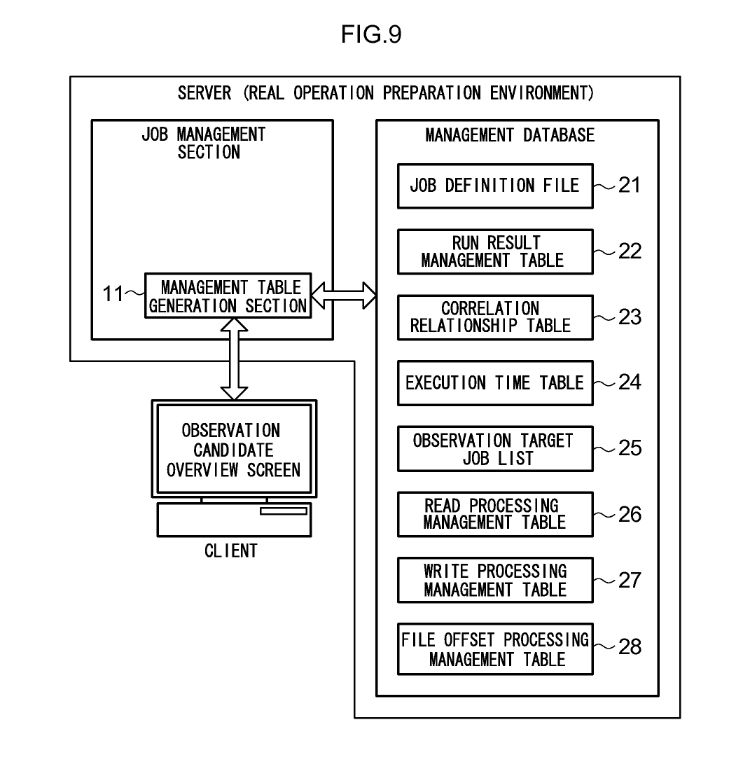

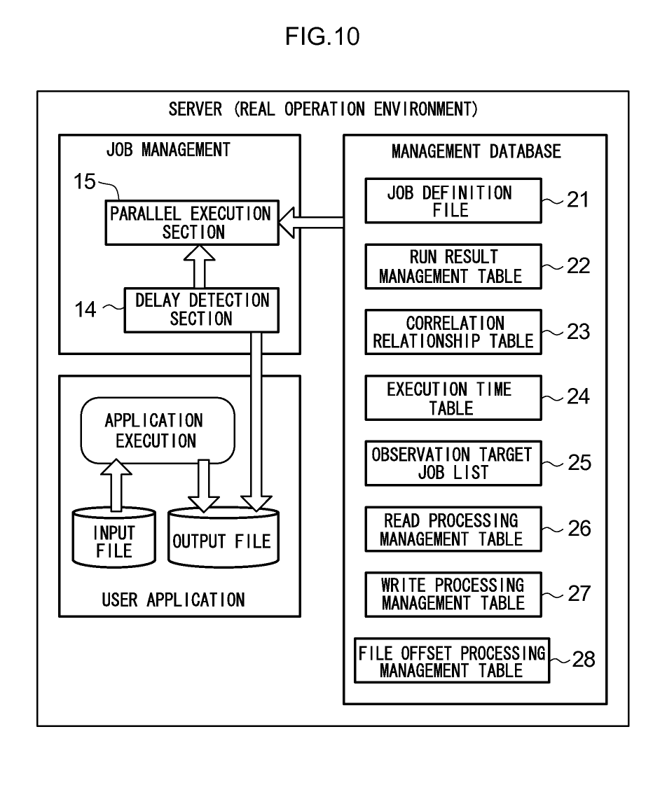

As illustrated in FIG. 7, a job discrimination device 10 according to the present exemplary embodiment includes a management table generation section 11, an extraction job discrimination section 12, an alteration job discrimination section 13, a delay detection section 14, and a parallel execution section 15. The management table generation section 11 is a functional section that functions when a server on which the job discrimination device 10 is installed operates in a test environment, or operates in a real operation preparation environment as illustrated in FIG. 8 and FIG. 9. The extraction job discrimination section 12 and the alteration job discrimination section 13 are functional sections that function when a server on which the job discrimination device 10 is installed operates in the test environment, as illustrated in FIG. 8. The delay detection section 14 and the parallel execution section 15 are functional sections that function when a server on which the job discrimination device 10 is installed operates in a real operation preparation environment, as illustrated in FIG. 10. Description follows regarding each of the functional sections, with reference to FIG. 8 to FIG. 10.

As illustrated in FIG. 8, in the server, real execution of an application registered as a user application is executed in a test environment to perform test operation of the application under management of a job management section. The application executed in the present exemplary embodiment is an application that executes plural jobs sequentially by batch processing.

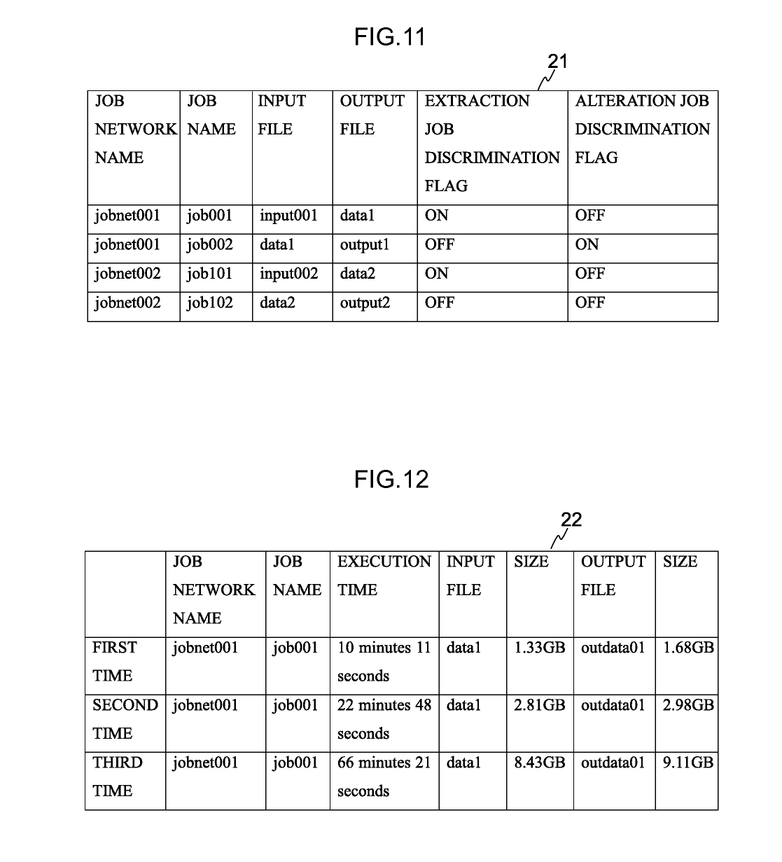

During the test operation, the management table generation section 11 acquires from real execution of the application registered as the user application: a job network name and job names to be executed by the application, input files of the respective jobs, and output files. The jobs are individual batch files, shell scripts, commands, and the like that configure the job network. The job network is an assembly of related jobs. The management table generation section 11 then generates a job definition file 21 like that illustrated in FIG. 11 for example, and stores the job definition file 21 in a management database (DB). Columns are also provided in the job definition file 21 for an extraction job determination flag, and an alteration job determination flag, described below.

At initiation of execution of the application, the respective extraction job determination flag and alteration job determination flag for each job are all set to OFF. For jobs discriminated as an extraction job or an alteration job by the extraction job discrimination section 12 and the alteration job discrimination section 13, described below, the extraction job determination flag or the alteration job determination flag is set to ON by the extraction job discrimination section 12 and the alteration job discrimination section 13.

Moreover, during execution of the application in the test operation, the management table generation section 11 registers, for the respective jobs, execution times, file names and sizes of the input files, and file names and sizes of output files. The management table generation section 11 then generates a run result management table 22 like that illustrated for example in FIG. 12, and registers the run result management table 22 in the management database. As the registration timings of each information, the file names and sizes of the input files are registered at job initiation time, the file names and sizes of the output files are registered at job completion time, and the execution times are registered at job completion time. The application is normally executed plural times in test operation with several variations, and load tests (performance tests), such as for large data volumes, are carried out. The management table generation section 11 accordingly generates the run result management table 22 registered with run result data for tests carried out plural times.

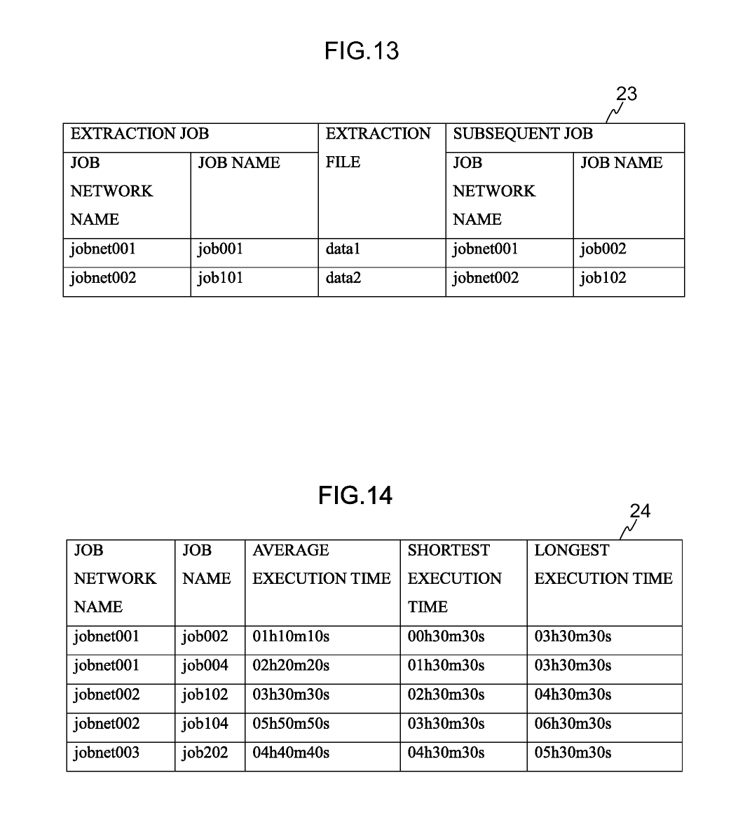

The management table generation section 11 also acquires from the job definition file 21 extraction jobs for which the extraction job determination flag has been set to ON. The management table generation section 11 also acquires subsequent jobs for which the output file of the acquired extraction job (referred to as the extraction file below) is the input file from the job definition file 21. The management table generation section 11 then generates from the acquired information a correlation relationship table 23, like that illustrated in FIG. 13 for example, for the extraction jobs and the subsequent jobs, and stores the correlation relationship table 23 in the management database.

The management table generation section 11 also extracts execution time information for the respective jobs from the run result management table 22, and calculates an average execution time, a shortest execution time, and a longest execution time. The management table generation section 11 then generates an execution time table 24 for the observation target job like that illustrated in FIG. 14, and stores the execution time table 24 in the management database. The average execution time is the result of dividing the total of the execution times by the number of tests, the shortest execution time is the smallest value out of all of the execution times, and the longest execution time is the largest value out of all of the execution times.

Using the procedure below, the management table generation section 11 generates from the run result management table 22 a correlation relationship equation for the size of the input file and the job execution time for the respective jobs.

(1) Take the job with the smallest input file size as a reference job.

(2) Find ratios between the size of the input file of the reference job and each other job (ratio (size)).

(3) Find ratios between the execution time of the reference job and each other job (ratio (time)).

(4) Find the ratio (time)÷the ratio (size) for the jobs other than the reference job as a correlation value.

(5) Find the average value (average correlation value) of the correlation value.

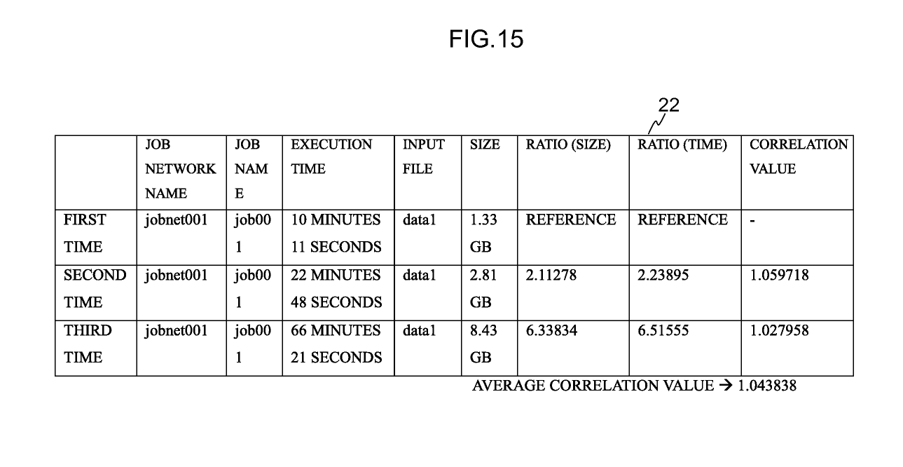

FIG. 15 illustrates an example in which the ratios (size), the ratios (time), the correlation values, and the average correlation value found by the management table generation section 11 are tabulated together with the run result management table 22. The management table generation section 11 then defines the correlation relationship equation below.

Correlation relationship=& time (variable)÷reference job execution time÷average correlation value×size of input file of reference job

This correlation relationship equation is a calculation equation that is solved by substituting the &time (variable) with the time at which the subsequent job can execute (time until the scheduled completion time), and solving the equation to calculate the size of the input file for which processing by the subsequent job is possible within that time. The management table generation section 11 stores the derived correlation relationship equation in the job definition file 21.

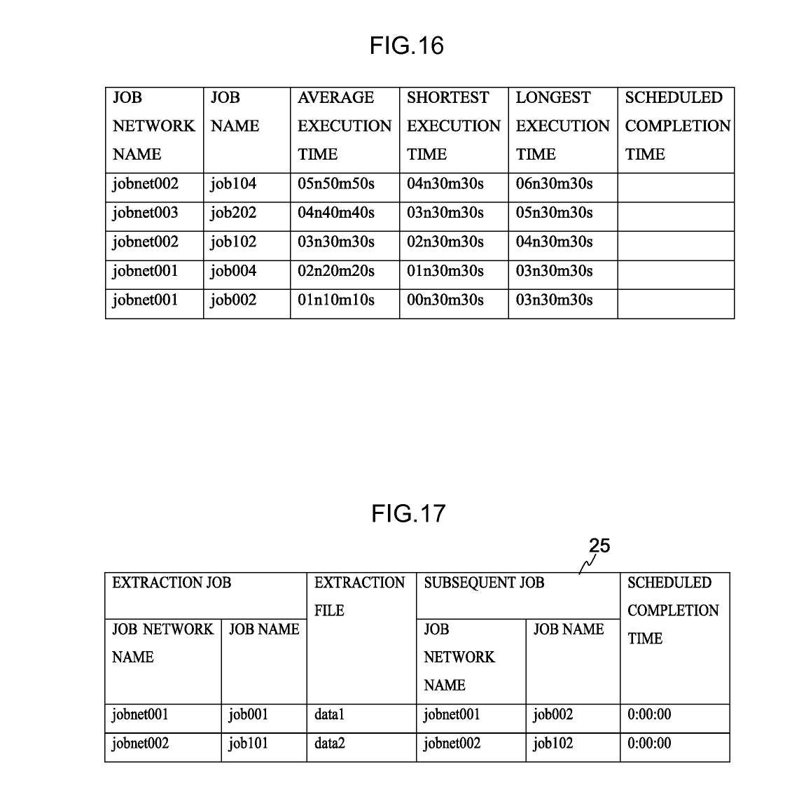

The management table generation section 11 sorts the execution time table 24 generated for the monitored job during test operation into descending order of the longest execution times, and generates an observation candidate overview like that illustrated for example in FIG. 16. Note that the average execution time or the shortest execution time may also be employed to sort jobs with the same longest execution time. A column capable of storing scheduled completion times is also provided in the observation candidate overview. The management table generation section 11 then displays an observation candidate overview screen on the client device, as illustrated in FIG. 9, and receives scheduled completion times of respective jobs from the client. As illustrated for example in FIG. 17, the management table generation section 11 associates the received scheduled completion time for each of the jobs with the subsequent job in the correlation relationship table 23 generated during test operation, and stores the associations. A prior job to the subsequent job for which the scheduled completion time was stored becomes an observation target job of delay detection. Namely, the correlation relationship table 23 to which the scheduled completion times were added becomes an observation target job list 25.

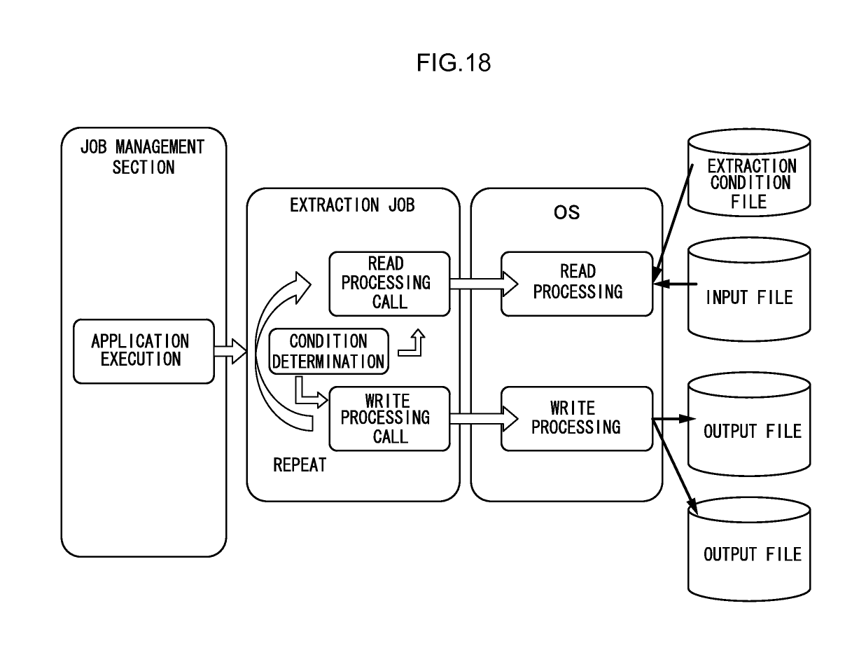

During test operation, the extraction job discrimination section 12 observes access by the application to input files and output files by each of the jobs being executed, and discriminates extraction jobs by the characteristics of each of the jobs. Typical characteristics of extraction jobs are listed in FIG. 18 and below.

(1) The input file is read sequentially in record units from the start until the end, or read sequentially from the start of the file in fixed size divisions (sequential reading).

(2) When the value of a given column of records matches an extraction condition specified in an extraction job, the records are sequentially written to the output file as record units, or in fixed size divisions, without performing alteration to each record (sequentially writing).

(3) The output file is not limited to a single file, and a relationship between the plural output files is defined according to an extraction condition in an extraction condition file.

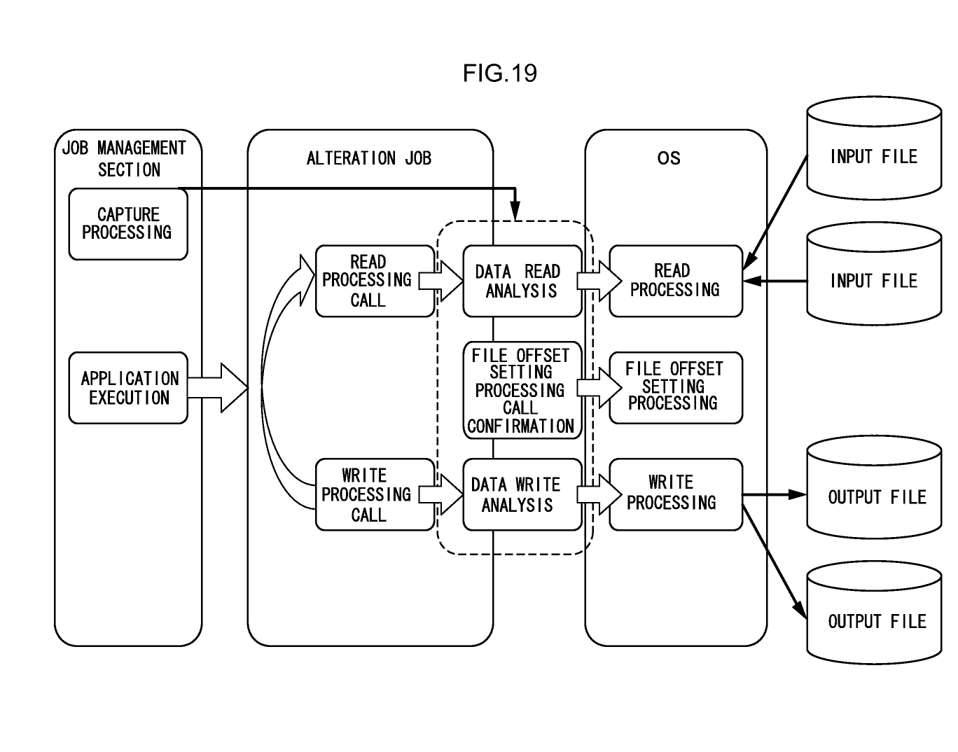

In order to discriminate jobs having the above characteristics, as illustrated in FIG. 19, the extraction job discrimination section 12 captures processing that reads input files of the respective jobs, processing that writes to the output files, and file offset setting processing, and analyzes the captured information. Note that the file offset setting processing is set to be called when random reading of input files is performed, and when random writing to output files is performed. Capture processing may be implemented using operating system (OS) functionality.

Specifically, the extraction job discrimination section 12 substitutes a library so that the read processing and the write processing diverts to data read analysis and data write analysis respectively. In order to ascertain whether or not the file offset setting processing has been called, the extraction job discrimination section 12 substitutes a library so that calls for file offset processing diverts to a file offset setting processing call confirmation. Capture of read processing, write processing, and file offset setting processing may be performed by executing the job after substituting the libraries. Note that setting of the capture processing may be performed by the alteration job discrimination section 13, described below.

The extraction job discrimination section 12 discriminates extraction jobs based on the data read analysis result, the data write analysis result, and the confirmation result of the file offset setting processing call. Note that determination of characteristics (2) and (3) of the extraction jobs is also possible since analysis results corresponding to read processing of extraction condition files are also included in the data read analysis result. The extraction job discrimination section 12 sets the extraction job discrimination flags of the job definition file 21 generated by the management table generation section 11 to ON for the jobs discriminated to be extraction jobs.

The alteration job discrimination section 13 discriminates whether or not each of the jobs executed during the test operation are alteration jobs that perform alteration processing having a processing result independent of unit processed. In the present exemplary embodiment, the alteration jobs below are discriminated as alteration jobs.

(1) Data format conversion processing

(2) Sort processing

(3) Data combination processing (aggregation processing)

(4) Inter-data reference processing (merge processing)

(5) Master reflection processing

(1) Data format conversion processing is processing that converts the data format of each input data. (2) Sort processing is processing that sorts the input data. (3) Data combination processing (aggregation processing) is processing that combines plural input files into a single output file without modification. (4) Inter-data reference processing (merge processing) is processing that sorts or merges input data included in plural input files, and outputs a single combined output file. (5) Master reflection processing is processing that causes data of other input files to be reflected in a single input file acting as a master.

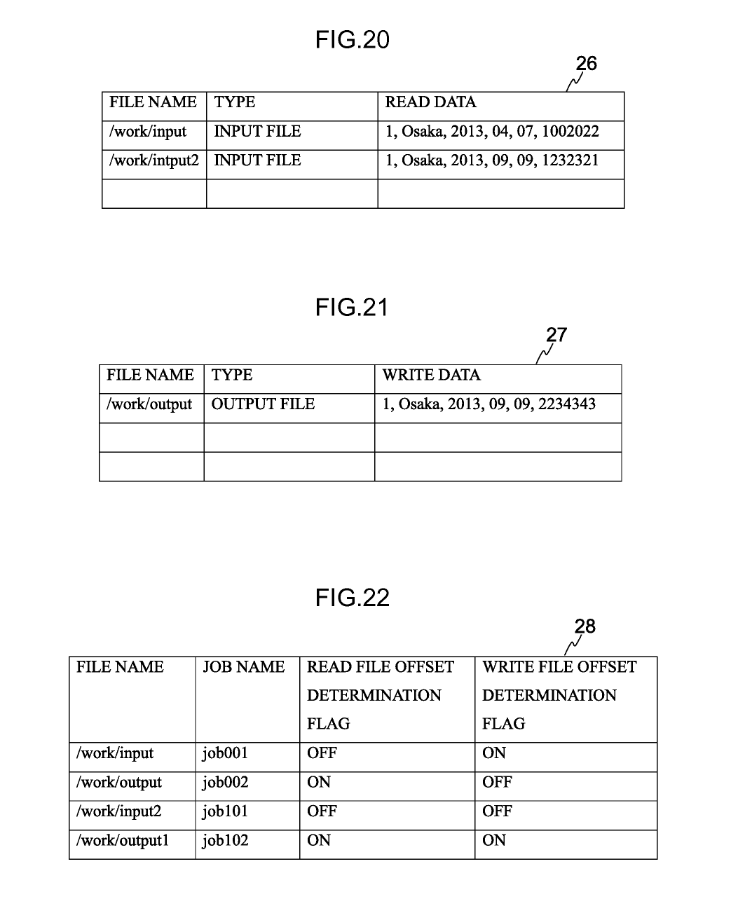

The alteration job discrimination section 13 acquires information capable of elucidating relationships between input files and output files for respective jobs using similar capture processing to that of the extraction job discrimination section 12. More specifically, the alteration job discrimination section 13 acquires a file name, a file type (input file), and data of each read record (read data) captured from read processing. The alteration job discrimination section 13 then generates a read processing management table 26 from the acquired information, like that illustrated in FIG. 20 for example, and stores the read processing management table 26 in the management database. Similarly, the alteration job discrimination section 13 acquires a file name, a file type (output file), and data of each written record (write data) captured from write processing. The alteration job discrimination section 13 then generates from the acquired information a write processing management table 27, like that illustrated in FIG. 21 for example, and stores the write processing management table 27 in the management database.

The alteration job discrimination section 13 also acquires file offset information captured from the file offset setting processing. The alteration job discrimination section 13 then generates a file offset processing management table 28 from the acquired information, like that illustrated for example in FIG. 22, and stores the file offset processing management table 28 in the management database. The file offset processing management table 28 is a management table for recording determination flags indicating whether or not file offset setting processing was called during data reads and during data writes for each of the jobs. The alteration job discrimination section 13 sets the read file offset determination flag or the write file offset determination flag to ON for jobs in which file offset setting processing is called during reads or writes.

The alteration job discrimination section 13 excludes from discrimination as alteration jobs any jobs that do not read from the leading record until the end record of the input file. This is because there are no cases of alteration jobs or aggregation jobs in which an input file is only read up to a midway point. Explanation follows regarding discrimination conditions for above alteration jobs (1) to (5).

The alteration job discrimination section 13 discriminates as an alteration job that executes (1) data format conversion processing any jobs fulfilling the conditions below.

The number of input files and the number of output files is one each

The number of output records matches the number of input records

Records exist for which there is no one-to-one correspondence between an input record and an output record

Note that in one-to-one correspondence between the input records and the output records, each input record matches a respective output record, disregarding the storage sequence of the records.

The alteration job discrimination section 13 discriminates as an alteration that executes (2) sort processing any jobs fulfilling the conditions below.

The number of input files and the number of output files is one each

There is a one-to-one correspondence between input records and output records

The number of output records matches the number of input records

The alteration job discrimination section 13 discriminates as an alteration job that executes (3) data combination processing any jobs fulfilling the conditions below.

There are plural input files, and the output file is a single file

The number of input records matches the number of output records

Write processing is sequential

The alteration job discrimination section 13 discriminates as an alteration job that executes (4) inter-data reference processing any jobs fulfilling the conditions below.

There are plural input files, the output file is a single file

The number of input records matches the number of output records

The write processing uses random access

### Or:

There are plural input files, the output file is a single file

The number of output records is greater than the number of input records

The input files and the output files do not match

The number of records of one of the input files matches the number of records of the output file

The alteration job discrimination section 13 discriminates as an alteration job that executes (5) master reflection processing any jobs fulfilling the conditions below.

There are plural input files, the output file is a single file

The number of input records is greater than the number of output records

One of the input files matches the output file

The alteration job discrimination section 13 sets the alteration job determination flag of the job definition file 21 stored in the management database to ON for jobs discriminated as alteration jobs.

For each of the jobs of the application executed during the real operation, the delay detection section 14 determines whether or not the job is an extraction job defined as an observation target job in the observation target job list 25. When the job currently executing is an extraction job defined as an observation target job, the delay detection section 14 observes the output files of that extraction job. The delay detection section 14 then acquires at specified intervals (for example, every minute) the size of the output file (extraction file), namely, the size of the output data of the extraction job at the time of observation (referred to as extraction data below).

The delay detection section 14 calculates the time difference between the current time and the scheduled execution completion time of the subsequent job to the observation target job, substitutes the time difference as the “&time” of the correlation relationship equation, and computes a size of an input file for which processing of the subsequent job is possible within the scheduled execution completion time. The delay detection section 14 then raises a delay detection alarm when the size of the extraction data acquired from the output file during observation exceeds the size of input files processable within the computed time difference.

When the delay detection alarm is raised by the delay detection section 14, the parallel execution section 15 acquires from the correlation relationship table 23 the subsequent job to the extraction job for which a delay was detected. The parallel execution section 15 also references the alteration job determination flag of the job definition file 21, and determines whether or not the acquired subsequent job is a job discriminated as an alteration job by the alteration job discrimination section 13. The parallel execution section 15 references the read file offset determination flag of the file offset processing management table 28, and determines whether or not the read processing of the subsequent job is sequential. When the subsequent job is discriminated as an alteration job by the alteration job discrimination section 13 and the read processing is sequential, the parallel execution section 15 then outputs instruction to the application such that the subsequent job is executed in parallel with the extraction job started previously and currently being executed.

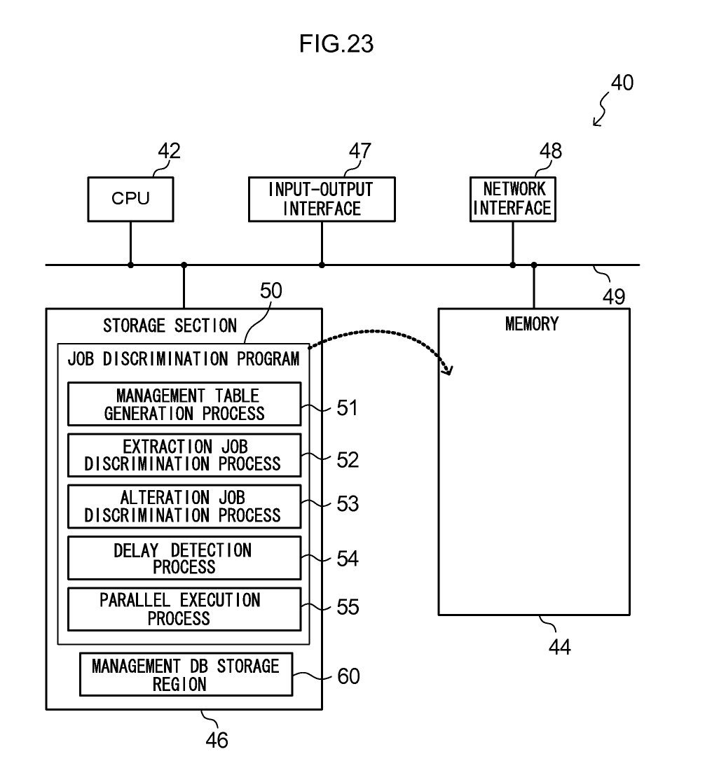

The job discrimination device 10 may be implemented by, for example, a computer 40 illustrated in FIG. 23. The computer 40 includes a CPU 42, memory 44, non-volatile storage section 46, an input-output interface (I/F) 47, and a network I/F 48. The CPU 42, the memory 44, the storage 46, the input-output I/F 47, and the network I/F 48 are mutually connected by a bus 49.

The storage section 46 may be implemented by a hard disk drive (HDD), flash memory, or the like. The storage section 46 acting as a recording medium is stored with a job discrimination program 50 that causes the computer 40 to function as the job discrimination device 10. The storage section 46 also includes a management DB storage region 60 that stores data representing each table stored in the management database.

The CPU 42 reads the job discrimination program 50 from the storage section 46, expands the job discrimination program 50 into the memory 44, and sequentially executes the processes included in the job discrimination program 50. The CPU 42 also reads data sorted in the management DB storage region 60 of the storage section 46, and generates each table by expanding the data into the memory 44.

The job discrimination program 50 includes a management table generation process 51, an extraction job discrimination process 52, an alteration job discrimination process 53, a delay detection process 54, and a parallel execution process 55. The CPU 42 operates as the management table generation section 11 illustrated in FIG. 7 by executing the management table generation process 51. The CPU 42 operates as the extraction job discrimination section 12 illustrated in FIG. 7 by executing the extraction job discrimination process 52. The CPU 42 operates as the alteration job discrimination section 13 illustrated in FIG. 7 by executing the alteration job discrimination process 53. The CPU 42 operates as the delay detection section 14 illustrated in FIG. 7 by executing the delay detection process 54. The CPU 42 operates as the parallel execution section 15 illustrated in FIG. 7 by executing the parallel execution process 55. The computer 40 executing the job discrimination program 50 thereby operates as the job discrimination device 10.

Note that the job discrimination device 10 may also be implemented by a semiconductor integrated circuit, for example, more specifically by an Application Specific Integrated Circuit (ASIC) or the like.

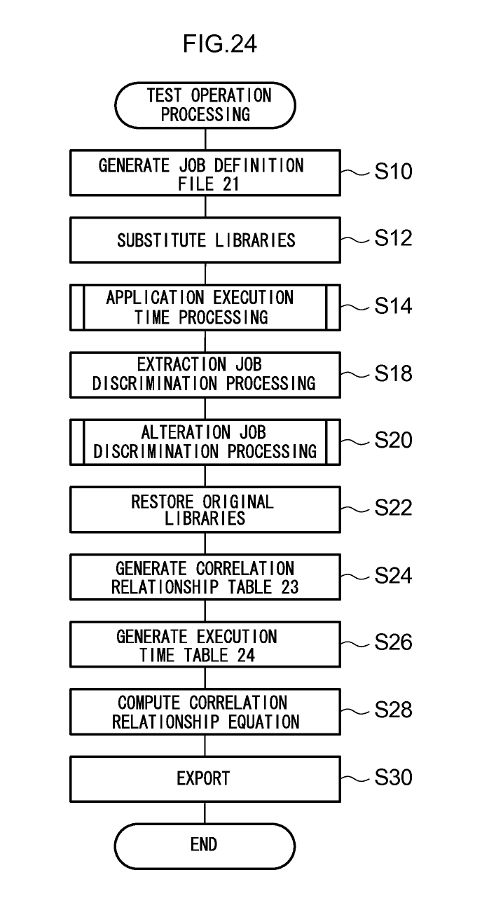

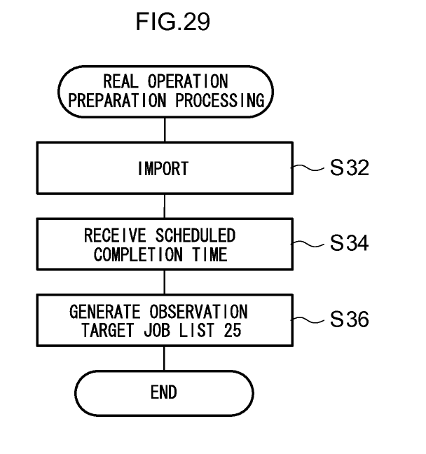

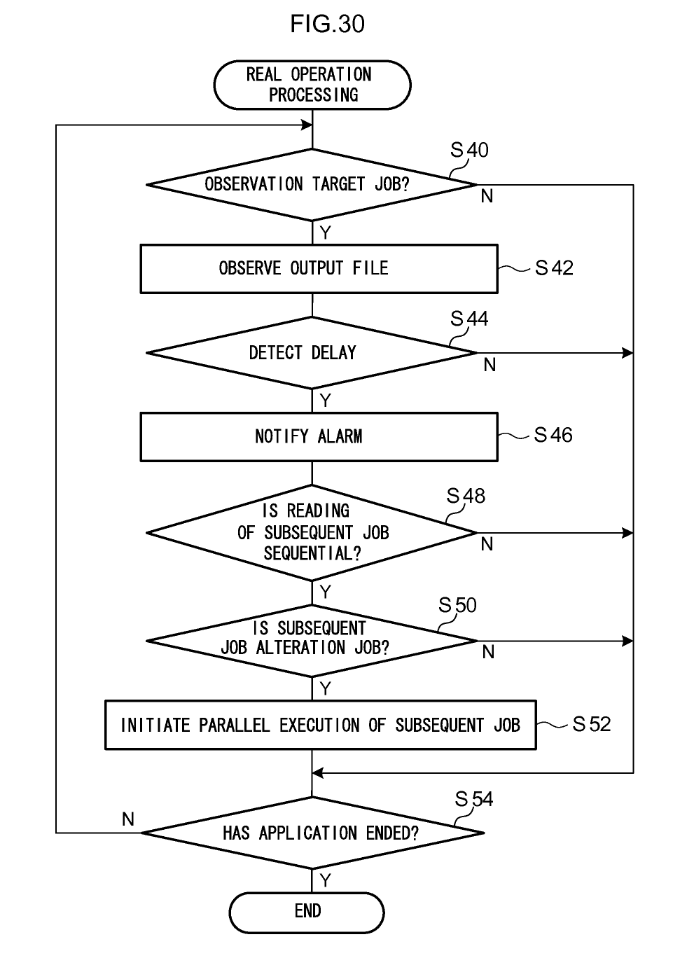

Explanation next follows regarding the operation of the job discrimination device 10 according to the present exemplary embodiment. There are three modes in the present exemplary embodiment: a test operation mode, a preparation mode for real operation, and a real operation mode. The mode of execution is set from a client device. When test operation mode is set from the client server, the test operation processing illustrated in FIG. 24 is executed by the job discrimination device 10. When the preparation mode for real operation is set from the client device, the real operation preparation processing illustrated in FIG. 29 is executed by the job discrimination device 10. When the real operation mode is set from the client device, the real operation processing illustrated in FIG. 30 is executed by the job discrimination device 10.

At step S10 of the test operation processing illustrated in FIG. 24, the management table generation section 11 acquires from real execution of the application registered as a user application the job network name and the job names to be executed in the application, and the input files and the output files of the respective jobs. The management table generation section 11 then generates the job definition file 21 like that illustrated in FIG. 11 for example, and stores the job definition file 21 in the management database.

Next, at step S12 the alteration job discrimination section 13 substitutes a library such that for each job, read processing from input files and write processing to output files diverts to data read analysis and data write analysis respectively. In order to determine whether or not the file offset setting processing was called, the alteration job discrimination section 13 also replaces a library so that the file offset setting processing diverts to the file offset setting processing call confirmation. After substituting the libraries, the alteration job discrimination section 13 outputs an execution instruction to the application. The extraction job discrimination section 12 may perform the processing of the current step.

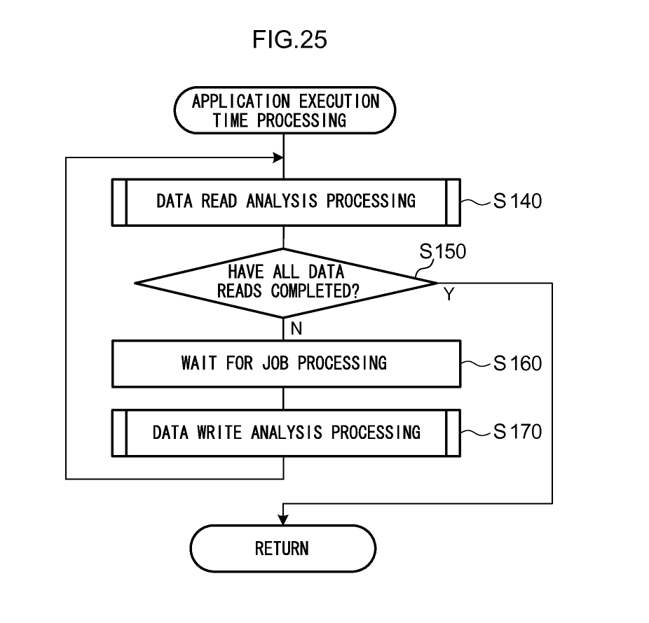

Next, at step S14, during execution of the application, the application execution time processing illustrated in detail in FIG. 25 is executed. The application execution time processing is executed for each of the respective jobs.

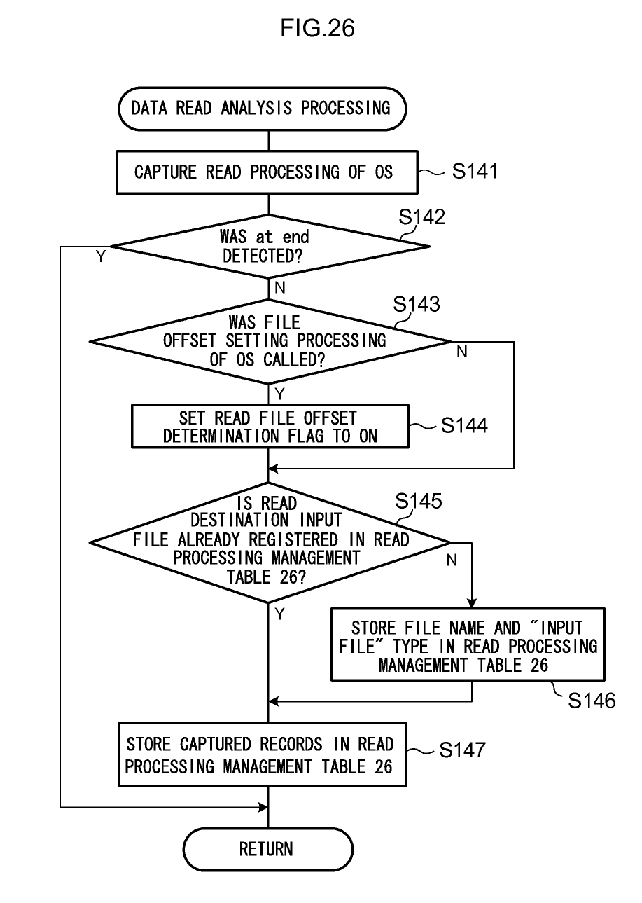

At step S140 of the application execution time processing illustrated in FIG. 25, the data read analysis processing illustrated in detail in FIG. 26 is executed. At step S141 of the data read analysis processing, the alteration job discrimination section 13 captures read processing that reads one record from a file input by the OS. At the current step, the management table generation section 11 stores the file name and the size of the input file in the run result management table 22 at the initiation time of the respective jobs.

Next, at step S142, the alteration job discrimination section 13 determines whether or not “at end”, indicating that reading until the end record has completed, was detected in the capture processing of step S141 above. When “at end” was detected, the data read analysis processing ends, and the processing returns to the application execution time processing. However, when “at end” is not detected, the processing transitions to step S143.

At step S143, the alteration job discrimination section 13 determines whether or not file offset setting processing was called by the OS. The processing transitions to step S144 when file offset setting processing was called, and the processing transitions to step S145 when file offset setting processing was not called.

At step S144, the alteration job discrimination section 13 sets to ON the read file offset determination flag corresponding to that input file in the file offset processing management table 28.

Next, at step S145 the alteration job discrimination section 13 determines whether or not the input file that is the read destination of the read processing of the OS is already registered in the read processing management table 26. The processing transitions to step S146 when the input file is not yet registered. At step S146, based on the information captured at step S141 above the alteration job discrimination section 13 registers the file name of the input file, and “input file” as the file type in the read processing management table 26, and then processing transitions to step S147. However processing transitions directly to step S147 when the input file is not already registered in the read processing management table 26.

At step S147, the alteration job discrimination section 13 registers the data of the record captured at step S147 in the data read row corresponding to the corresponding input file in the read processing management table 26. The data read analysis processing then ends, and the processing returns to the application execution time processing.

Next, at step S150 of the application execution time processing illustrated in FIG. 25, the alteration job discrimination section 13 determines whether or not reading of all of the data of the input file has completed. In the read analysis processing, affirmative determination is made when processing transitioned to the current step and “at end” was detected, and negative determination is made when processing transitioned to the current step and “at end” was not detected. The application execution time processing ends and the processing returns to the test operation processing when affirmative determination is made. Processing transitions to step 160 when negative determination is made.

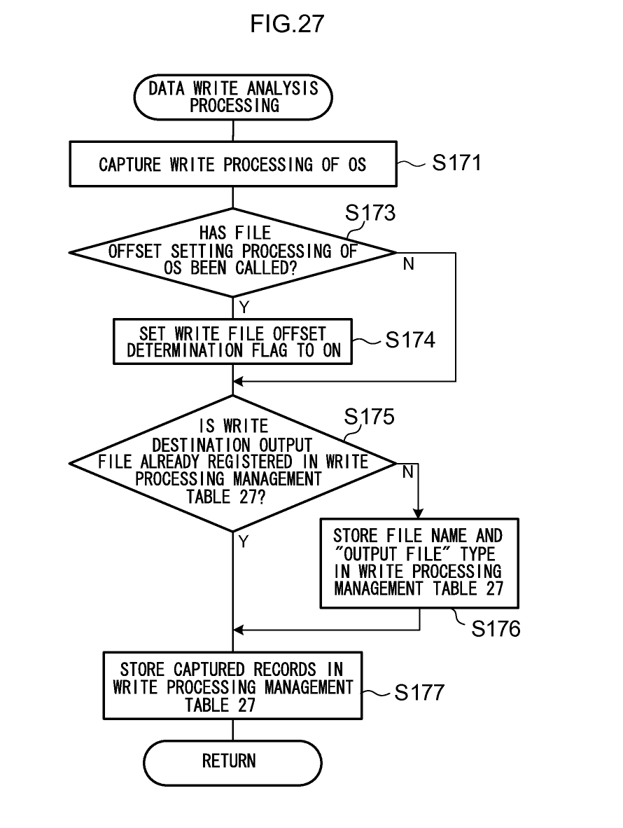

At step S160, processing waits until processing is performed on data read by execution of the application. Next, at step S170, the data write analysis processing illustrated in detail in FIG. 27 is executed. Explanation regarding the data write analysis processing is focused on points differing from the data read analysis processing illustrated in FIG. 26, and sections similar to those of the data read analysis processing are not explained in detail.

At step S171 of the data write analysis processing, the alteration job discrimination section 13 captures write processing of writing one record to an output file using the OS. When the completion time of each job is reached in the current step, the management table generation section 11 stores the file name and size of the output file, and the job execution time in the run result management table 22.

Next, at step S173, the alteration job discrimination section 13 determines whether or not the file offset setting processing of the OS was called. Processing transitions to step S174 when the file offset setting processing was called, and the alteration job discrimination section 13 sets the write file offset determination flag of the file offset processing management table 28 to ON. Processing transitions to step S175 when the file offset setting processing is not called.

At step S175, the alteration job discrimination section 13 determines whether or not the output file that is the write destination of the write processing of the OS is already registered in the write processing management table 27. Processing transitions to step S177 when the output file is already registered. When the output file is not yet registered, processing transitions to step S176, and the alteration job discrimination section 13 stores in the write processing management table 27 the file name of the output file and “output file” as the file type, and processing then transitions to step S177.

At step S177, the alteration job discrimination section 13 stores the record data captured at step S171 above in the data read column corresponding to the current output file in the write processing management table 27.

When the processing returns to the application execution time processing, processing returns to step S140. The application execution time processing ends when affirmative determination is made at step S150, and processing then returns to test operation processing.

Next, at step S18 of the test operation processing illustrated in FIG. 24, the extraction job discrimination section 12 discriminates whether or not each of the jobs is an extraction job based on the data read analysis result, the data write analysis result, and the file offset setting processing call result. For jobs discriminated as extraction jobs, the extraction job discrimination section 12 then sets to ON the extraction job discrimination flag of the job definition file 21 generated by the management table generation section 11.

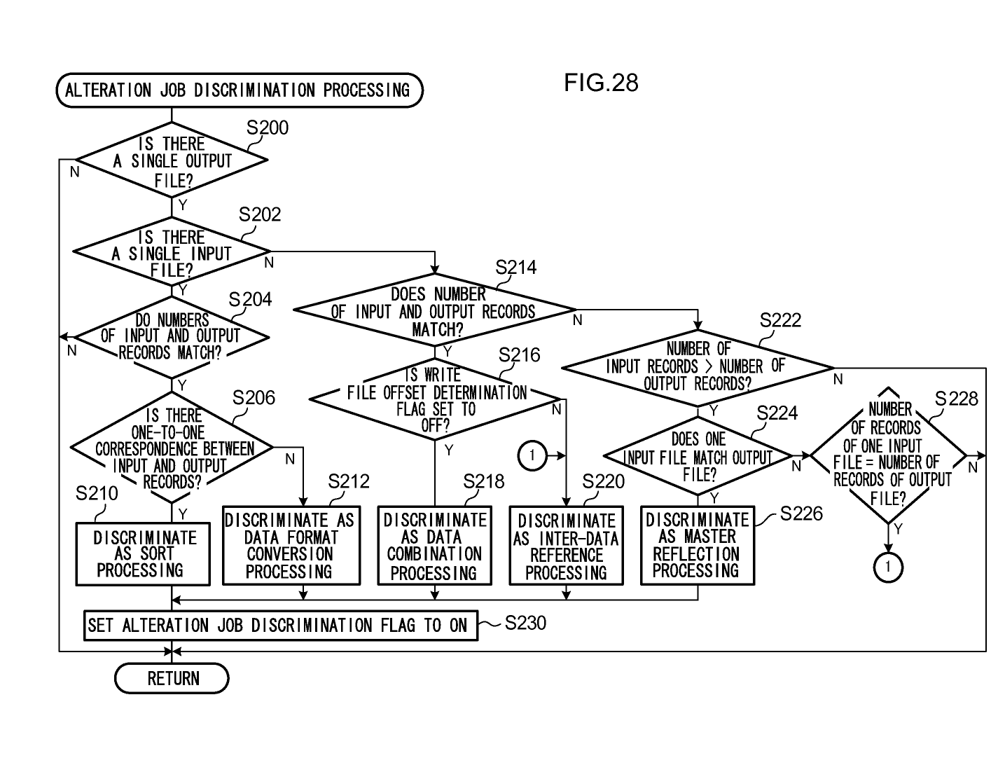

Next, at step S20, the alteration job discrimination section 13 executes the alteration job discrimination processing illustrated in detail in FIG. 28. In the alteration job discrimination processing, each of the jobs registered in the job definition file 21 is set one-by-one as discrimination target jobs, and the alteration job discrimination processing is executed. Jobs for which the extraction job determination flag is set to ON may be excluded from the discrimination target jobs.

At step S200 of the alteration job discrimination processing, the alteration job discrimination section 13 references the output file columns corresponding to the discrimination target jobs of the job definition file 21, and determines whether or not the number of output files is one. When there is a single output file, processing transitions to step S202, and when there are plural output files, alteration job discrimination processing ends since the discrimination target job is not an alteration job, and processing returns to test operation processing.

At step S202, the alteration job discrimination section 13 references the input file columns corresponding to the discrimination target jobs of the job definition file 21, and determines whether or not the number of input files is one. Processing transitions to step S204 when there is one input file, and processing transitions to step S214 when there are plural input files.

At step S204, the alteration job discrimination section 13 references the read processing management table 26, and acquires the number of records stored in the data read column corresponding to the input file of the discrimination target job (input records). Similarly, the alteration job discrimination section 13 references the write processing management table 27, and acquires the number of the records stored in the data write column corresponding to the output file of the discrimination target jobs (output records). The alteration job discrimination section 13 then determines whether or not the number of input records matches the number of output records. Processing transitions to step S206 when there is a match, and alteration job discrimination processing ends when there is no match since the discrimination target job is not an alteration job, and processing returns to test operation processing.

At step S206, the alteration job discrimination section 13 determines whether or not there is a one-to-one correspondence between input records and output records. Processing transitions to step S210 when there is a one-to-one correspondence, and the alteration job discrimination section 13 discriminates the discrimination target job as an alteration job that executes sort processing. However, when there a record for which there is no one-to-one correspondence between the input record and the output record, processing transitions to step S212, and the alteration job discrimination section 13 discriminates the discrimination target job as an alteration job that executes data format conversion processing.

However, when processing transitions to step S214 due to plural input files existing, similarly to at step S204 above, the alteration job discrimination section 13 determines whether or not the number of output records matches the number of input records. Processing transitions to step S214 when there is a match, and processing transitions to step S222 when there is no match.

At step S216, the alteration job discrimination section 13 determines whether or not the write file offset determination flag of the discrimination target job of the file offset processing management table 28 is set to OFF. When the flag is OFF, processing transitions to step S218, and the alteration job discrimination section 13 discriminates the discrimination target job as an alteration job that executes data combination processing. However, when the write file offset determination flag is ON, processing transitions to step S220, and the alteration job discrimination section 13 discriminates the discrimination target job as an alteration job that executes inter-data reference processing.

However, when processing transitions to step S222 due to the number of input records of the plural input files not matching the number of output records of the single output file, the alteration job discrimination section 13 discriminates by whether or not the number of input records is greater than the number of output records. Processing transitions to step S224 when the number of input records is greater. When the number of output records is greater, alteration job discrimination processing ends since the discrimination target job is not an alteration job, and processing returns to test operation processing.

At step S224, the alteration job discrimination section 13 determines whether or not any of the input files matches the output file. Processing transitions to step S226 when there is a match, and the alteration job discrimination section 13 discriminates the discrimination target job as an alteration job that executes master reflection processing. However, processing transitions to step S228 when none of the input files matches the output file.

At step S228, the alteration job discrimination section 13 determines whether or not the number of records of any of the input files matches the number of output records of the output file. When there is a match, processing transitions to step S220 and the alteration job discrimination section 13 discriminates the discrimination target job as an alteration job that executes inter-data reference processing. However, when the number records in none of the input files matches the number of output records of the output file, alteration job discrimination processing ends since the discrimination target job is not an alteration job, and processing returns to test operation processing.

At step S230, the alteration job discrimination section 13 sets the alteration job determination flag of the job definition file 21 to ON for the jobs discriminated as alteration jobs at step S210, S212, S218, S220, or S226 above. Alteration job discrimination processing then ends, and processing returns to test operation processing.

Next, at step S22 of the test operation processing illustrated in FIG. 24, the alteration job discrimination section 13 restores the original libraries that were substituted out at step S12 above.

Next, at step S24 the management table generation section 11 acquires from the job definition file 21 the extraction jobs for which the extraction job determination flag is set to ON. The management table generation section 11 also acquires from the job definition file 21 any subsequent jobs that have the output file of an acquired extraction job as an input file. The management table generation section 11 then generates from the acquired information the correlation relationship table 23 for the extraction jobs and the subsequent jobs, like that illustrated for example in FIG. 13, and stores the correlation relationship table 23 in the management database.

Next, at step S26, for each job, the management table generation section 11 extracts execution time information from the run result management table 22, and computes the average execution time, the shortest execution time, and the longest execution time. The management table generation section 11 then generates the execution time table 24 of the observation target jobs, like that illustrated for example in FIG. 14, and stores the execution time table 24 in the management database.

Next, at step S28, the management table generation section 11 defines the correlation relationship equation between the size of the input files and the job execution time for each job from the migration result management table 22, and stores the correlation relationship equations in the job definition file 21.

Next, at step S30, the management table generation section 11 exports the data represented by each table stored in the management database, and test operation processing ends.

Explanation next follows regarding the real operation preparation processing illustrated in FIG. 29. At step S32, the management table generation section 11 imports data exported by the test operation processing into the real operation environment.

Next, at step S34 the management table generation section 11 sorts the longest execution times of the observation target jobs in the execution time table 24 generated during test operation into descending order, and generates the observation candidate overview, like that illustrated for example in FIG. 16. The observation candidate overview is also provided with a column capable of storing scheduled completion times. The management table generation section 11 then displays the observation candidate overview screen on the client device as illustrated in FIG. 9, and receives the scheduled completion time of each job from the client.

Next at step S36, the management table generation section 11 registers the scheduled completion times of each of the received jobs, in association with the subsequent job of the correlation relationship table 23 generated during test operation, and generates the observation target job list 25. The preparation for real operation testing processing then ends.

Explanation next follows regarding the real operation processing illustrated in FIG. 30. When the real operation mode is set from the client terminal, execution of the application is initiated on the server installed with the job discrimination device 10. When the execution of the application is initiated, at step S40 of the real operation processing the delay detection section 14 determines whether or not the job currently being executed by the application is an extraction job defined as an observation target job in the observation target job list 25. Processing transitions to step S42 for an observation target job, and processing transitions to step S54 for a job that is not an observation target job.

At step S42, the delay detection section 14 observes the output files of the extraction jobs that are observation target jobs. The delay detection section 14 then acquires the size of the output file (extraction file), namely the size of the output data of the extraction job at the observation time (referred to as extraction data below) at specified intervals (for example, every minute).

Next, at step S44 the delay detection section 14 references the observation target job list 25, and calculates the time difference between the current time and the scheduled execution completion time of the subsequent job to the observation target job. The delay detection section 14 then substitutes the “&time” of the correlation relationship equation stored in the job definition file 21 with the calculated time difference, and computes a size of an input file to enable processing of the subsequent job within the scheduled execution completion time. The delay detection section 14 then determines whether or not a delay was detected by determining whether or not the size of the extraction data acquired from the output file during observation exceeds the size of input files processable within the computed time difference. Processing transitions to step S46 when a delay is detected, and processing transitions to step S54 when a delay was not detected.

At step S46, the delay detection section 14 raises the delay detection alarm, and notifies the delay to the parallel execution section 15. Next, at step S48 the parallel execution section 15 acquires the subsequent job to the extraction job for which the delay was detected from the correlation relationship table 23. Moreover, the parallel execution section 15 determines whether or not the read processing of the subsequent job is sequential by determining whether or not the read file offset determination flag of the file offset processing management table 28 is set to OFF. When the read file offset determination flag of the subsequent job is set to OFF, determination is made that the read processing of the subsequent job is performed sequentially, and processing transitions to step S50. When the read file offset determination flag is set to ON for the subsequent job, the read processing of the subsequent job uses random access, and so processing transitions to step S54 since parallel execution cannot be performed with the prior extraction job.

At step S50, the parallel execution section 15 determines whether or not the subsequent job was discriminated as an alteration job by the alteration job discrimination section 13 by determining whether or not the alteration job determination flag of the job definition file 21 is set to ON. Processing transitions to step S52 when the alteration job determination flag of the subsequent job is set to ON. When the alteration job determination flag of the subsequent job is set to OFF, processing transitions to step S54 since the subsequent job cannot be executed in parallel with the prior execution job.

At step S52, the parallel execution section 15 outputs instruction to the application such that the subsequent job is executed in parallel with the extraction job previously started and currently being executed.

Next, at step S54 the delay detection section 14 determines whether or not the application has ended. Processing returns to step S40 when the application has not ended, and the real operation processing is ended when the application has ended.

As explained above, according to the job discrimination device 10 according to the present exemplary embodiment, determination is made as to whether or not processing executed by the jobs is processing having a processing result independent of unit processed based on the relationships between the input data and the output data of the jobs. Jobs that execute processing having a processing result independent of unit processed are then discriminated as alteration jobs. The present exemplary embodiment is able to make clear discrimination between aggregation jobs and alteration jobs in batch processing since processing having a processing result dependent on unit processed is executed in the case of aggregation jobs.

Moreover, according to the job discrimination device 10 according to the present exemplary embodiment, when the subsequent job to the extraction job is an alteration job and a job that performs sequential reading, the subsequent job is executable in parallel with the extraction job that is the prior job. This is because processing result issues do not arise when alteration jobs executing processing having a processing result independent of unit processed are executed in parallel with the prior job.

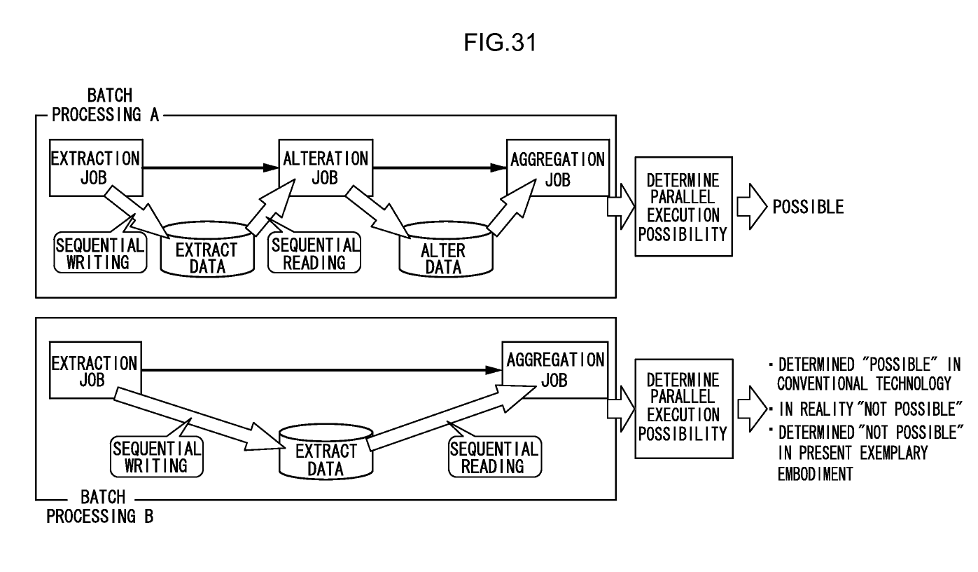

As illustrated in FIG. 31, in batch processing A, the subsequent job to the extraction job is an alteration job, and write processing of the extraction job and read processing of the alteration job are sequential. In such a case, determination is made that the extraction job and the alteration job that is the subsequent job are executable in parallel in both conventional technology and in the present exemplary embodiment. However, in batch processing B as illustrated in FIG. 31, the subsequent job to the extraction job is an aggregation job, and write processing of the extraction job and read processing of the aggregation job are both sequential. In such a case, determination is made that the extraction job and the aggregation job that is the subsequent job are executable in parallel in the case of conventional technology. However, since the processing result of the aggregation processing is processing unit dependent, the aggregation processing is not executable in parallel with the extraction job. As described above, due to the present exemplary embodiment determining whether or not parallel execution is possible in conjunction with determining whether or not the subsequent job is an alteration job that executes processing that is processing result independent, thereby enabling parallel execution of the jobs to be performed without causing processing result issues.

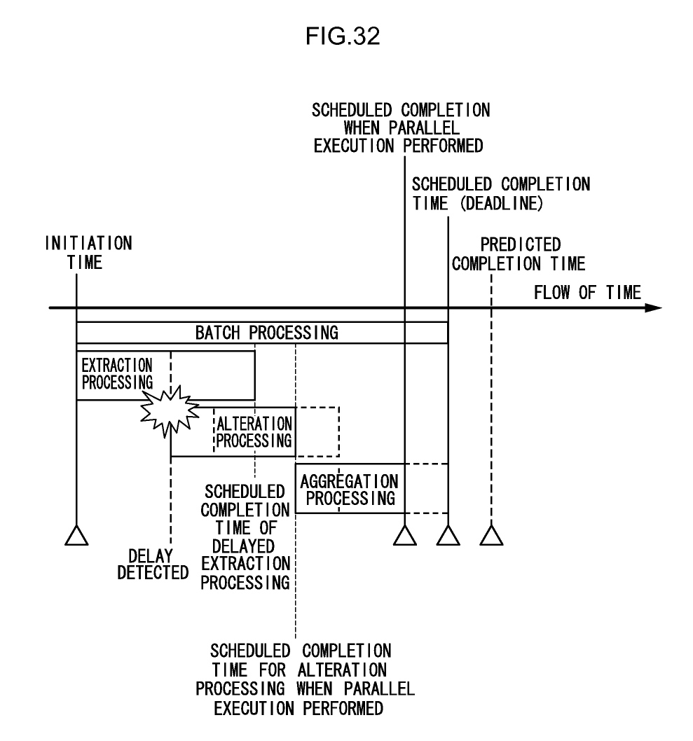

Moreover, in the job discrimination device 10 according to the present exemplary embodiment, since the prior job is executed in parallel with the subsequent job when a delay is detected during execution of the application, as illustrated in FIG. 32, automatic delay avoidance is enabled in addition to detection of the delay.

Note that although explanation has been given regarding a case in which the prior job executed in parallel with the subsequent job is an extraction job in the present exemplary embodiment, there is not limitation thereto. Parallel execution is possible provided that (1) the write processing of the prior job is sequential, (2) the read processing of the subsequent job is sequential, and (3) the subsequent job is discriminated as an alteration job by the present exemplary embodiment. In the present exemplary embodiment, extraction jobs are first discriminated, and prerequisite (1) is fulfilled automatically since the extraction job is the prior job. Determination as to whether or not prerequisite (1) is fulfilled is therefore not performed in the processing to determine whether or not parallel execution is possible in the real operation processing illustrated in FIG. 30 (step S48, and step S50). In cases in which the prior job is not limited to an extraction job, processing to reference the write file offset determination flag of the job for which a delay was detected (the job currently executing) and to determine whether or not that write processing of that job is sequential may be added to the processing to determine whether or not parallel execution is possible.

Moreover, although explanation has been given in the above exemplary embodiment regarding a case in which the subsequent job executable in parallel is executed in parallel with the prior job when a delay was detected, there is not limitation thereto. Configuration may be made such that parallel execution is performed when the subsequent job to the job currently executing is a job executable in parallel, regardless of whether there is a delay.

Moreover, although explanation has been given regarding a case in which delays are detected based on the output data amount of the extraction job in the present exemplary embodiment, delays may be detected using other methods.

Although explanation has been given above in which the job discrimination program 50 is pre-stored (installed) in the storage section 46, the job discrimination program 50 may be provided in a format recorded on a recording medium such as a CD-ROM or a DVD.

Depending on the job processing, problems sometimes arise in the results due to instigating parallel execution, and cases exist in which business issues result. For example, in cases in which the processing of the subsequent job is aggregation processing, errors arise in the aggregation results of the subsequent job due to executing in parallel with the prior job. Determination as to whether or not access to input-output files is sequential gives rise to cases of jobs being determined to be parallel execution targets for jobs such as aggregation processing where problems arise when executed in parallel.

An aspect of the technology disclosed herein has the advantageous effect of enabling discrimination of data alteration jobs having the characteristic of being executable in parallel with other jobs.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the technology disclosed herein have been described in detail, it should be understood that the various changes, substitutions, and alterations could be made hereto without departing from the spirit and scope of the invention.

What is claimed is:

1. A job discrimination method, comprising:
acquiring input-output information including information of an input file from which a job that executes specific processing reads data, information of input data included in the input file, information of an output file to which the job writes data, information of output data included in the output file, and information of an access method to the output file; and
by a processor, based on the input-output information, discriminating, as a data alteration job, a job in which a pattern indicated by a relationship between a number of the input files and a number of the output files, a relationship between a number of items of the input data and a number of items of the output data, a relationship between the input data and the output data, and the access method to the output file, matches a pattern predetermined as a pattern arising when processing having a processing result independent of a processing unit has been executed.

2. The job discrimination method of claim 1, wherein the processing having a processing result independent of a processing unit is at least one selected from the group consisting of processing that converts a data format of each input data item, processing that sorts input data, processing that combines input data contained in a plurality input files into a single output file without alteration, processing that performs sorting or merging of input data contained in a plurality of input files and combines the merged or sorted data into a single output file, and processing that reflects input data of another input file in a single input file that is a master.

3. The job discrimination method of claim 1, further comprising:
acquiring the input-output information, which further includes information of an access method to the input file for each of a plurality of jobs included in batch processing having output data of a prior job as input data for a subsequent job; and
executing the prior job in parallel with the subsequent job in cases in which the access method to the output file of the prior job is sequential, the access method to the input file of the subsequent job is sequential, and the subsequent job is a job discriminated as a data alteration job.

4. The job discrimination method of claim 3, further comprising:
predicting the time required by at least a single job in the batch processing;
detecting whether or not delays will arise in the batch processing based on the predicted time and a scheduled target time; and
executing the prior job in parallel with the subsequent job in cases in which a delay is detected.

5. A job discrimination device, comprising:
a processor configured to execute a process, the process comprising:
acquiring input-output information including information of an input file from which a job that executes specific processing reads data, information of input data included in the input file, information of an output file to which the job writes data, information of output data included in the output file, and information of an access method to the output file; and
based on the input-output information, discriminating, as a data alteration job, a job in which a pattern indicated by a relationship between a number of the input files and a number of the output files, a relationship between a number of items of the input data and a number of items of the output data, a relationship between the input data and the output data, and the access method to the output file, matches a pattern predetermined as a pattern arising when processing having a processing result independent of a processing unit is executed.

6. The job discrimination device of claim 5, wherein the processing having a processing result independent of a processing unit is at least one selected from the group consisting of processing that converts a data format of each input data item, processing that sorts input data, processing that combines input data contained in a plurality input files into a single output file without alteration, processing that performs sorting or merging of input data contained in a plurality of input files and combines the merged or sorted data into a single output file, and processing that reflects input data of another input file in a single input file that is a master.

7. The job discrimination device of claim 5, the process further comprising:
acquiring the input-output information, which further includes information of an access method to the input file for each of a plurality of jobs included in batch processing having output data of a prior job as input data for a subsequent job; and
executing the prior job in parallel with the subsequent job in cases in which the access method to the output file of the prior job is sequential, the access method to the input file of the subsequent job is sequential, and the subsequent job is a job discriminated as a data alteration job.

8. The job discrimination device of claim 7, the process further comprising:
predicting the time required by at least a single job in the batch processing;
detecting whether or not delays will arise in the batch processing based on the predicted time and a scheduled target time; and
executing the prior job in parallel with the subsequent job in cases in which a delay is detected.

9. A non-transitory recording medium storing a job discrimination program that causes a computer to execute a process, the process comprising:
acquiring input-output information including information of an input file from which a job that executes specific processing reads data, information of input data included in the input file, information of an output file to which the job writes data, information of output data included in the output file, and information of an access method to the output file; and
based on the input-output information, discriminating, as a data alteration job, a job in which a pattern indicated by a relationship between a number of the input files and a number of the output files, a relationship between a number of items of the input data and a number of items of the output data, a relationship between the input data and the output data, and the access method to the output file, matches a pattern predetermined as a pattern arising when processing having a processing result independent of a processing unit is executed.

10. The non-transitory recording medium of claim 9, wherein the processing having a processing result independent of a processing unit is at least one selected from the group consisting of processing that converts a data format of each input data item, processing that sorts input data, processing that combines input data contained in a plurality input files into a single output file without alteration, processing that performs sorting or merging of input data contained in a plurality of input files and combines the merged or sorted data into a single output file, and processing that reflects input data of another input file in a single input file that is a master.

11. The non-transitory recording medium of claim 9, the process further comprising:
acquiring the input-output information, which further includes information of an access method to the input file for each of a plurality of jobs included in batch processing having output data of a prior job as input data for a subsequent job; and
executing the prior job in parallel with the subsequent job in cases in which the access method to the output file of the prior job is sequential, the access method to the input file of the subsequent job is sequential, and the subsequent job is a job discriminated as a data alteration job.

12. The non-transitory recording medium of claim 11, the process further comprising:
predicting the time required by at least a single job in the batch processing;
detecting whether or not delays will arise in the batch processing based on the predicted time and a scheduled target time; and
executing the prior job in parallel with the subsequent job in cases in which a delay is detected.
